(19) United States
(12) Patent Application Publication
(10) Pub. No.: US 2004/0125776 A1
(43) Pub. Date: Jul. 1, 2004

(54) Peer-to-peer wireless data communication system with progressive dynamic routing

(76) Inventors: Hans C. Haugli, Ottawa (CA); Michael M. Zuliani, Ottawa (CA)

Correspondence Address: MARKS & CLERK, P.O. BOX 957, STATION B, OTTAWA, ON, K1P 5S7, CA

(21) Appl. No.: 10/367,830

(22) Filed: Feb. 19, 2003

Related U.S. Application Data
(60) Provisional application No. 60/435,999, filed on Dec. 26, 2002.

(51) Int. Cl. H04L 12/28

(52) U.S. Cl. 370/338; 370/392; 709/238

(57) ABSTRACT

A peer to peer wireless data communication system includes a number of mobile data terminals operating over a wide area and organized into one more peer groups forming a dynamic multi-hopping mesh-like network. Each terminal operates in a sleep mode in order to conserve power and includes a transceiver to permit the direct exchange of wireless messages containing routing information including a destination address with any other terminal within range, and a processor programmed to prepare outgoing messages and extract the routing information contained within the wireless messages. When the routing information contains an identification code of the receiving terminal, it either presents a received message for local processing in the receiving terminal if the received message is addressed thereto or forwards (relays) the received message to another terminal according to extracted routing information or by computing locally a route to the final destination.

### CROSS REFERENCE TO RELATED APPLICATION

This application claims the benefit under 35 USC 119(e) of U.S. provisional application Ser. No. 60/435,999 filed on Dec. 26, 2002.

### FIELD OF THE INVENTION

This invention relates to the field of wireless data communication, and in particular to a method of exchanging data, especially text messages, between a plurality of terminals organized into one or more peer groups. The invention permits the exchange of messages between a plurality of mobile terminals where the propagation path is dynamically variable and where terminal power consumption and wide range are important parameters. Although the invention is primarily designed for use in mobile networks, it is also applicable to networks where at least some of the terminals are fixed stations.

### BACKGROUND OF THE INVENTION

Most wireless data networks involving small hand portable terminals use a centralized base station that communicates and relays messages to and from fixed and mobile terminals. Data messages exchanged between individual mobile terminals are generally routed via base stations controlled by a data switch. This is true, for example, of text messaging with cell phones. In centralized systems coverage is extended by maximizing the transmitted EIRP of the base station and mobiles plus mounting the base station antenna as high as possible and clear of any obstructions. The high cost and complexity of such centralized systems usually requires a high density of users in order to justify the necessary investment. Moreover, it is generally necessary to subscribe to a public service, such as a cell phone service, which may not always be available. A public service is an expensive solution where only a modest number of users want to be in continual communication with each other, for example, in a school environment where a group of students, may wish to be in communication with each other but have no particular need to communicate, at least on a frequent basis, with users outside their own peer group. U.S. Pat. No. 5,903,618 to Miyake et al. discloses a paging system that permits peer-to-peer communication. However, such communication is only possible with the intervention of a base station and when the terminals are in range for direct communication with each other.

Another example of this type of centralized system is the IEEE 802.11 standard, designed for short range high capacity wireless local area computer networks which has come to be known as WiFi. Despite the simplicity and low cost of WiFi base stations (access points), it has limitations related to the short range which results from the need to establish high capacity wireless links. Further each high capacity link when active uses nearly one third of the allocated bandwidth thereby severely limiting the number of discrete stations that can be supported within a particular geographic area. This has particular inefficiencies and deleterious affects for applications which do not require large amounts of bandwidth such as messaging and e-mail.

WiFi also supports an ad hoc peer to peer mode of operation, but generally all peers must be within direct range of each other in order to communicate thus limiting range. The Internet Engineering Task Force Mobile Ad Hoc Networking Working Group has recently issued an Ad-hoc On-demand Distance Vector (AODV) draft protocol specification that determines routing paths for message transfer between terminals that are not within direct range via a form of dynamic multi-hop routing between participating nodes. This approach, which is based upon IP, determines a route by an originating station to a destination station the first time a message has to be transferred. Each node then periodically verifies that its neighbors are present as long as the path is required. If a neighbor is no longer present an error message is sent to the route originator. The route originator will then have to re-broadcast route request information again to establish a new route. This protocol may struggle in dynamic environments where terminals move rapidly in and out of range of each other due to local obstructions or changes in local radio frequency interference and in particular where terminals are required to operate in a sleep mode to conserve power consumption.

The use of sleep mode is a known technique in mobile communications to reduce a receiver's average power consumption. The sleep period however introduces additional delays and complexities in messaging between nodes since they are not always available to receive messages or broadcasts of updated routing information. This would be problematic in a system such as WiFi where individual receivers are generally required to be active and where a carrier sensing technique is used to manage transmissions within the network. The potential use of WiFI and AODV, to a dynamic mobile environment, with sleep mode introduces significant additional delays during message transfer to a point that a valid route may not be sustainable over sufficient time This approach is therefore not well suited for mobile data applications requiring wide range, a large number of users, low bandwidth utilization, low message latency and low terminal power consumption.

A further example of wireless data technology is known as Bluetooth which was designed to provide short range wireless data links between various fixed and portable terminals. This technology also supports peer to peer messaging among a limited number of peers within close proximity of each other. Data transfer among peers is controlled by a master station. A few local networks can be connected to form a scatter network using terminals present in both networks, which act as bridges between the masters. The performance and the number of local networks that can be linked together is however severely limited due to the fact that bridging terminals must spend time in each network. This type of system is also not well suited to a dynamic mobile environment requiring communication between a larger number of peers roaming over a wide area.

### SUMMARY OF THE INVENTION

The present invention offers a fully distributed very low cost mobile data system featuring wide range, direct peer to peer communications, and automatic and dynamic real time routing and relaying among peers in order to extend the range and establish communications between peers with no direct contact. It employs small low cost battery operated hand portable terminals with no need for a base station or master terminal to improve over-all robustness. To save power and to minimize cost the transmit power is kept low (<100 mW). Furthermore, the terminals employ sleep mode technology so that the power consuming circuitry is only active during specific time intervals. The sleep mode has been implemented in a way that minimizes system response time and maximizes throughput. This low transmit power would normally limit the coverage area, but in accordance with the principles of the invention, the individual terminals can be used dynamically as relays for links that could not otherwise be established directly. The sleep mode would normally limit the system response time in establishing dynamic routing and data transfer between nodes but in accordance with the fully distributed properties of this invention common routing information is automatically formed and updated individually in all peer terminals as the propagation environment changes. Dynamic frequency and traffic routing assignment are also employed to mitigate local radio frequency interference. Controlled access is further provided to data networks such as the Internet allowing for extended coverage to fixed and other remote terminals. Efficient low bandwidth links with dynamic frequency hopping permits a large number of disparate peer groups to co-exist within the same localized geographic area. According to the principles of the invention it will be possible to establish, at very low cost, a large number of independent wide area peer to peer wireless data systems, each characterized by small hand portable communicators.

According to the present invention there is provided a wireless data communication system comprising a plurality of data terminals, at least some of which are mobile and which are organized into one or more peer groups forming a dynamic mesh-like network of connection paths between any of said terminals either directly or via intervening peer terminals; and each said terminal having a sleep mode in which said terminal consumes minimal power and is inoperative to receive wireless communications, and an active mode during which said terminal is operative to receive direct wireless communications from nearby peer terminals within reception range, said terminal including: a transceiver to permit the direct exchange of wireless messages containing routing information including a destination address with any nearby peer terminal; a memory for storing a connectivity table containing the connection paths to other terminals within said one or more peer groups; and a processor, said processor being programmed while in said active mode to: (i) to transmit at intervals control messages containing characteristic information necessary for said nearby terminals to communicate with said terminal; (ii) to exchange status messages with nearby terminals to update said connectivity table; (iii) to prepare an outgoing data message with routing information that depends on an instantaneous operational state of the terminals in said system; and (iv) to extract routing information contained within incoming data messages having a destination address and, when said routing information in said incoming data messages contains an identification code of said receiving terminal, either present a received message for local processing in said receiving terminal if said destination address corresponds the address of the receiving terminal or else to relay said incoming data message to another terminal on a connection path to the destination address.

The control message carries the information necessary for nearby terminals, that is terminals within direct range of each other, to communicate with said terminal. Typically, this can be terminal identification and timing information as well as a frequency hopping code. A particular terminal will only be active to receive communications during a one or more timeslots determined by its own internal clock. In order to communicate, a nearby terminal needs to know when the receiving terminal is available to receive communications. The control messages convey this information. Since the terminals operate in an asynchronous mode, the timing information usually consists of the timing offset relative to the transmission time of the control message. The receiving terminal can then store the timing offset relative to its own internal clock.

The system status messages carry information to permit the formation and updating of connectivity tables in the individual terminals. When a new terminal logs on, or when a terminal changes position, this information is rapidly propagated throughout the network.

The use of direct peer to peer communications without a base station as well as neighboring mobile terminals as relays to other terminals requires up to date knowledge of connectivity between terminals. Connectivity can change rapidly and therefore terminals search at intervals for new connections, check existing connections and update dynamically a shared connectivity table whenever a change of state occurs. The shared connectivity table is resident in each mobile terminal and changes are distributed to all local terminals either directly or via other terminals.

When a terminal wishes to send a message to another terminal, the originating terminal determines the least hop path to the destination terminal using its own internal tables. The message can thus be sent without any delay, even if no message has previously been sent to a particular destination. If there is a change of state during transfer the invention also permits data to be re-routed at each node in response to the state change.

The terminals operate in an asynchronous mode. Each terminal upon initial power up scans for control messages, transmitted at intervals by each other terminal within the peer network. Control messages transmitted by individual terminals contain essential frequency, timing and addressing information necessary to establish communication with it. All messages are transmitted in narrow time slots with a low duty cycle. These time slots are selected to minimize message collision among peers. A new terminal entering the network upon detecting the presence of a peer will log into that peer and receive from it an updated connectivity table. The presence of the new peer and updated connectivity table are also communicated to the other peers within the network. Transmission of data messages between peers takes place at intervals and within unique time slots dynamically and independently selected by each peer. This allows for multiple users to access the peer network through time sharing. Further the transmission of data messages between peers always commence at the recipient's particular time slot. If the message exceeds the capabilities of one time slot the receiving terminal is instructed to continue its reception for the duration of the message transfer.

Narrowband transmission with frequency hopping is employed to minimize interference and to maximize the number of simultaneous users and independent peer networks within a particular coverage region. In this context “narrowband” is contrasted with “wideband” as used, for example, in WiFi systems where the information bit rate is typically greater than one Mbps. Typically, narrowband information bit rates are less than 100 kbps, preferably in the order of 10 kbps. A specific frequency hopping code is selected from a pre-determined list by each peer group to establish communications. The code may be subsequently modified to minimize interference. Each terminal monitors and maintains an internal table of it own local interference environment. This data is used to determine an individual frequency hopping pattern for communication to said terminal. Such pattern is specified by each terminal and communicated to its peers within its individual control message. Control messages are transmitted via a frequency hopping pattern which is common to all members of the peer group.

Coverage is greatly extended through the ability to route a message dynamically via one or more intermediary terminals. While a base station is not necessary, in one embodiment of the invention, an access station can be employed, for example, to allow one group of terminals at one location to communicate with another group of terminals at another location, for example, using the Internet. The access station can act like a peer terminal, just relaying messages to other terminals in a peer group, or it can pass messages between peer terminals and servers connected to the Internet, or to another access station communicating with another group of terminals that may or may not form part of the same peer group. The access stations can be either public or private. Unlike base stations of a cellular network, the access stations do not provide a master function, and when used for relaying messages, they act in a similar manner to a mobile peer terminal.

Local terminals that that can not be easily reached via relaying may be reached using an extension or multicast form of transmission. In this mode a message is first distributed to all neighbors within as certain number of hops. The message is augmented with accurate transmit timing and frequency information and is retransmitted at the same time by all transmitters thereby increasing the likelihood of reception by a distant receiver which will receive energy via different paths and power from all terminals, thereby extending the range through path diversity and power combining. An important advantage of using frequency shift keying is that it allows non-coherent combining of signals in the extension mode. If two terminals transmit the same signal at approximately at the same time and frequency the energy in the receive frequency bins combine, to increase the total rms power received even though the signals are not coherent.

In another aspect the invention provides a data terminal for use in a wireless data communication system comprising a plurality of data terminals organized into one more peer groups forming a dynamic mesh-like network, at least some of said data terminals being mobile, a transceiver to permit the direct exchange of wireless messages containing routing information including a destination address with any nearby peer terminal, said terminal having a sleep mode in which said terminal consumes minimal power and is inoperative to receive wireless communications, and an active mode during which said terminal is operative to receive direct wireless communications from nearby peer terminals within reception range, and said terminal comprising a memory for storing a connectivity table containing the connection paths to other terminals within said one or more peer groups; and a processor, said processor being programmed while in an active mode to (i) to transmit at intervals control messages containing characteristic information necessary for said neighboring terminals to communicate with said terminal; (ii) to exchange status messages with nearby terminals to update said connectivity table; (iii) to prepare an outgoing data message with routing information that depends on an instantaneous operational state of the terminals in said system; and (iv) to extract routing information contained within incoming data messages having a destination address and, when said routing information in said incoming data messages contains an identification code of said receiving terminal, either present a received message for local processing in said receiving terminal if said destination address corresponds the address of the receiving terminal or else to relay said incoming data message to another terminal on the connection path to the destination address.

In a still further aspect the invention provides a method of establishing communication between a plurality of data terminals, at least some of said data terminals being mobile, comprising the steps of organizing a plurality of data terminals, at least some of which are mobile, into one or more peer groups forming a dynamic mesh-like network of connection paths between any of said terminals either directly or via intervening peer terminals, each said terminal having a sleep mode in which said terminal consumes minimal power and is inoperative to receive wireless communications, and an active mode during which said terminal is operative to receive direct wireless communications from nearby peer terminals within reception range; (i) transmitting at intervals control messages containing characteristic information necessary for said nearby terminals to communicate with the originating terminal; (ii) exchanging status messages with nearby terminals to update a connectivity table containing connection paths to other terminals within said one or more peer groups; (iii) preparing an outgoing data message with routing information that depends on an instantaneous operational state of the terminals in said system; and (iv) extracting routing information contained within incoming data messages having a destination address and, when said routing information in said incoming data messages contains an identification code of said receiving terminal, either present a received message for local processing in said receiving terminal if said destination address corresponds the address of the receiving terminal or else to relay said incoming data message to another terminal on the connection path to the destination address.

### BRIEF DESCRIPTION OF THE DRAWINGS

The invention will now be described in more detail, by way of example only, with reference to the accompanying drawings, in which:—

FIG. 1 is a network diagram illustrating the network architecture of the wireless communication system in accordance with one embodiment of the invention;

FIG. 2 illustrates message relaying within a peer group of terminals in accordance with one embodiment of the invention;

FIG. 3 is an idle state timing chart showing transmissions of the individual and group control messages;

FIG. 4 illustrates the login protocol timing diagram for a terminal;

FIG. 5 is an exemplary terminal connectivity table for a group of 15 peers

FIG. 6 illustrates a message packet with routing header and acknowledgement information;

FIG. 7 illustrates activity timing in both idle and message transfer modes;

FIG. 8 illustrates a group of terminals in the network range extension mode;

FIG. 9 shows the range extension protocol for the extension mode;

FIG. 10 is a block diagram of a terminal and an access station;

FIG. 11 is a log-in protocol flow chart for a terminal;

FIG. 12 is a software high level flow chart showing the operation of a terminal;

FIG. 13 is a flow chart showing the routing algorithm to determine a path to a destination terminal;

FIG. 14a illustrates one example of a connection path through the network;

FIG. 14b shows the table entries for the connection path shown in FIG. 14a;

FIG. 15 shows the table entries for the routing path determination described with reference to FIG. 14a;

FIG. 16 illustrates the non-coherent combining of signals in the extension mode;

FIG. 17 shows three active WiFi transmitters and reduced interference band-segments suitable for frequency sharing;

FIG. 18 shows the detailed contents of a control packet;

FIG. 19 is a high level flow chart for the connectivity update protocol;

FIG. 20 compares the protocols of AODV (WiFi) and one embodiment of the present invention; and

FIG. 21 illustrates the message relay protocol timing for terminals organized into a peer group.

### DESCRIPTION OF THE PREFERRED EMBODIMENTS

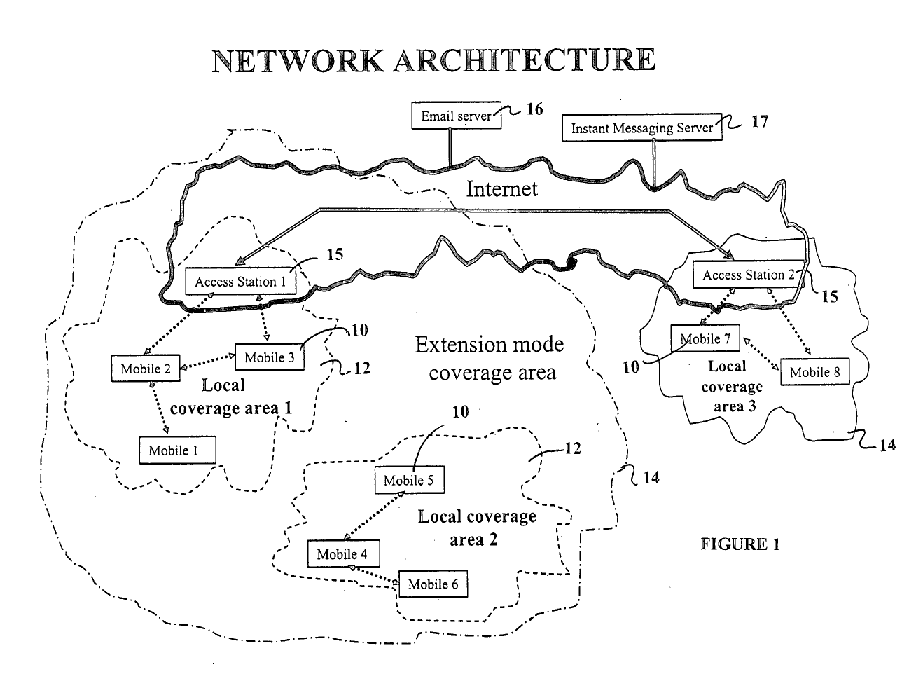

FIG. 1 shows an overview of the network architecture. Mobile terminals 10 capable of communicating with each other and forming a peer group are organized into local groups 12. Each terminal within a local sub-group 12 can communicate with another terminal in its local sub-group either directly or using another terminal in the group as a relay. Terminals within an extended range group 14 can communicate using an extended range mode wherein terminals within a particular local sub-group 12 transmit simultaneously to extend the range of a transmitted message. Access stations 15 can communicate with terminals within their associated groups. The access stations 15 are connected over the Internet and are able to access servers, such as email server 16 and instant messaging server 17, as well as other types of information that may be available on the Internet. The access stations, in addition to providing connectivity to servers and the like, can behave like ordinary peer terminals for relaying messages. The result is a dynamic mesh network where connection paths are established between terminals either directly or through the intermediary of intervening terminals acting as relays.

The terminals communicate in time slots using a frequency hopping spread spectrum technique. The terminals are asynchronous. Each terminal defines its own time slots. In order to save power, the terminals have a sleep mode and are only active in certain defined time slots. When logged in, the terminals can exchange status messages with each other to convey information about the status of the system. Each terminal maintains a connectivity table that provides information necessary to establish a connection path to any other terminal in the peer group. The connectivity table is in the form of a matrix identifying active direct links between neighboring terminals. Several links can be combined to provide a connection path between remote terminals.

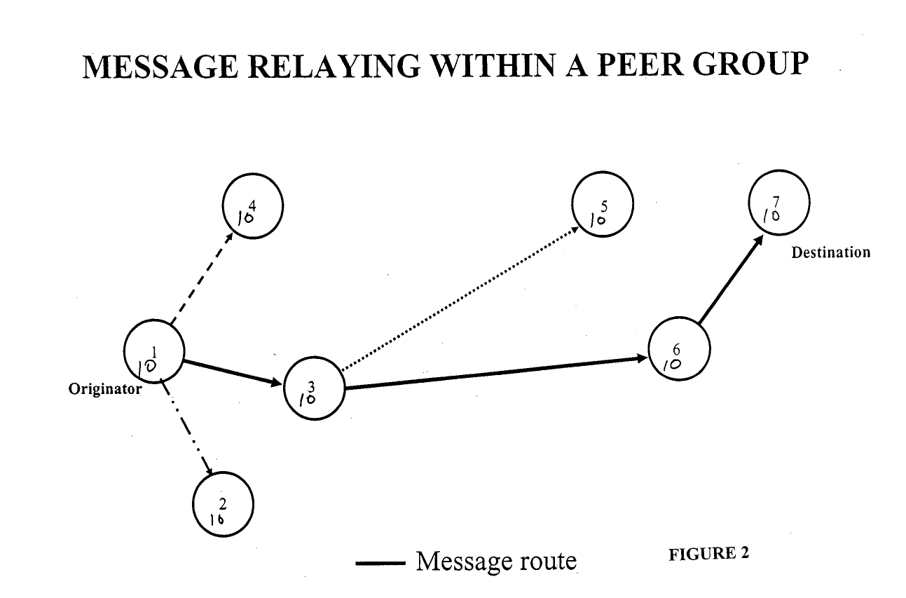

FIG. 2 illustrates how the relay method works. If terminal 10¹ wants to communicate with terminal 10⁷ forming part of the same local group 12, and terminal 10⁷ is not in direct range of terminal 10¹, it first sends the message to terminal 10³, which retransmits it to terminals 10⁶. This terminal in turn retransmits the message to the destination terminal 10⁷.

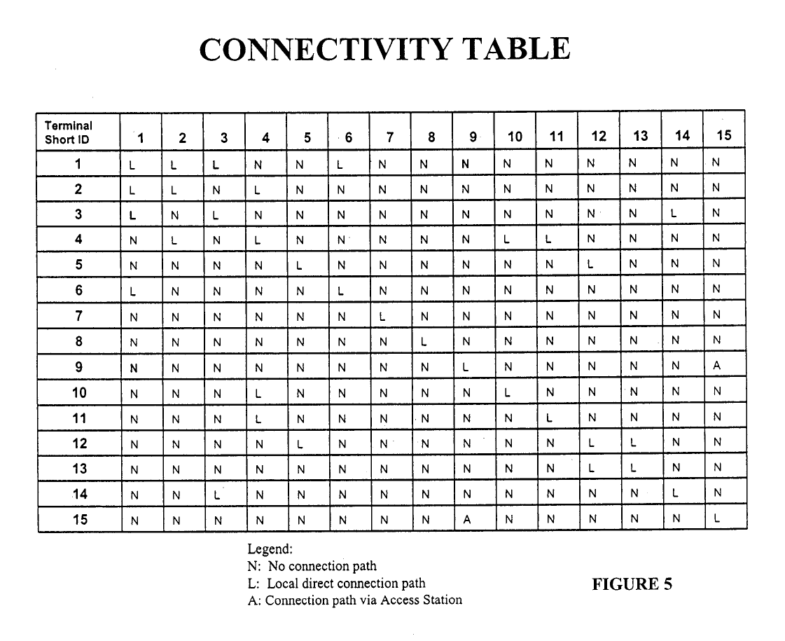

The originating terminal can insert complete routing information into the outgoing message so that each receiving terminal along a connection path to the destination relays the message to the next terminal identified in the routing information contained within the message. An intermediate terminal can update the routing information if the state of the system has changed and it determines that a better has become available, for example, due to the presence of additional terminals, or the original route is no longer valid as a result of the presence of obstructions or changes in the transmission environment. Alternatively, the originating terminal can forward an outgoing message to the first terminal on the connection path, which in turn establishes its own routing to the next hop on the connection path toward the destination terminal, and so on until the message reaches its final destination determined by the originating terminal. In order to determine the route to the destination terminal, each terminal maintains a connectivity table (FIG. 5) that specifies which neighbors are directly connected within the peer group.

When a new terminal 10 is first activated, the user enters identifying data, such as the Network Name (buddy list name), Terminal Short Number, Terminal Full Name, Network Access Code, Transmit Channel Code (Frequency & Spread Spectrum Frequency Hop Code) and Date/Time. Some of the information listed above may be automatically derived from the above data. This information is then used by the terminal during the login procedure to establish the presence of the terminal within a peer group and during subsequent operation of the terminal.

The active terminals continually transmit control messages in the idle state at intervals in timeslots determined by their own internal clocks. The control messages contain information specifying how to reach the transmitting terminal. This information is used to permit the exchange of messages to continually update the connectivity tables within the active terminals. Each time a new terminal is switched on, it performs a rapid scan of all timeslots, based on its local clock, to listen for control messages to determine if there are any neighbors within direct range. This scan is also used to select a quiet slot used for its periodic low duty cycle idle control transmit bursts. When the new terminal detects a control message, with the proper identifiers the new terminal will attempt to login to the originating terminal by sending a Connect Request containing the Network Access Code, Transmit Timeslot Offset and Proposed Dynamic ID. Following a successful login, both terminals exchange status messages to update their respective connectivity tables. The terminal being logged into sends a connectivity update containing the new terminal individually to all of its peers. The new terminal then attempt to login sequentially to all remaining neighbors in direct range using the same procedure When the new terminal logs in to the first active terminal, it receives the connectivity information of this terminal. This connectivity information specifies the active links between terminals that can be reached from this terminal, either directly or indirectly. Consequently, by looking at its connectivity table information, this terminal can identify a connection path to any terminal within its group. When the new terminal logs in to this active terminal, all terminals within the group of the active terminal become reachable by the new terminal.

Direct links between peers can only be established through a separate login process. As the new terminal subsequently logs in to additional active terminals, it establishes new direct links to these terminals that can be used as part of new connection paths within the mesh network. The connectivity tables of the active terminals are updated as required to reflect changes in state. The status of active connection paths are monitored at intervals by each terminal by observing the presence or absence over a period of time of control messages from neighboring terminals.

A specific example of a connectivity table is shown in FIG. 5. A copy of this table is replicated in each active terminal and continually update through the control message. In this table the terminals are given a short ID numbered from 1 to 15. The table in FIG. 5 indicates to the originating terminal how all other terminals in the peer group are connected. This table is used to determine the shortest route to another terminal. For example, terminal ID#6 can reach terminal ID# 1 through a local direct connection. Terminal #4 can reach terminal ID#2, ID#10, and ID#11 through direct links. If terminal ID#4, wants to send a message to terminal ID#1, the connectivity table shows that no direct link exists However, the connectivity table shows that terminal ID#4 can reach terminal ID#1 indirectly using terminal ID#2 as a relay. The connection path in this case between terminal ID#4 and terminal ID#2 consists of the links between terminal ID#4 and terminal ID# 2, and between terminal ID#2 and terminal ID#1.

The connectivity table, in this example, shows that terminal ID#15 is not a local terminal, since it has no direct links to any other terminal in the table, but can only be reached through terminal ID#9, which for this link acts as an access station to another network such as the internet.

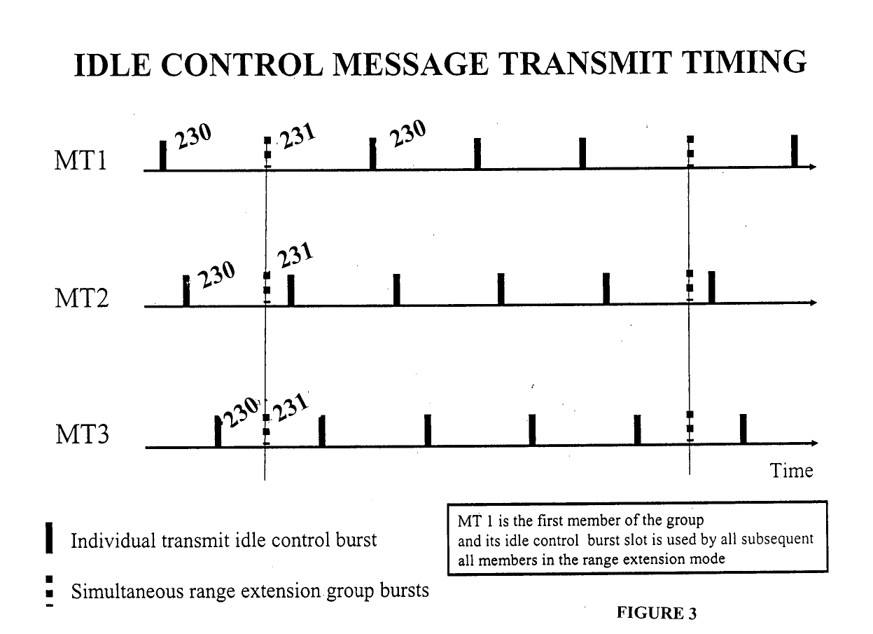

When a terminal becomes inactive, its neighbors detect the absence of its control message and determine the respective links to the inactive terminal are no longer available. The neighbors then update their internal connectivity tables to reflect the loss of these links and send out connectivity table update messages to their reachable peers FIG. 3 shows the control message timing for active terminals. The terminals are not synchronized with each other. Each terminal has its own internal clock and listens for incoming messages in a timeslot determined by its internal clock. Typically, each terminal has 125 timeslots in a one second frame, but the control message uses 625 timeslots in a five second super-frame to reduce collision probabilities and system overhead.

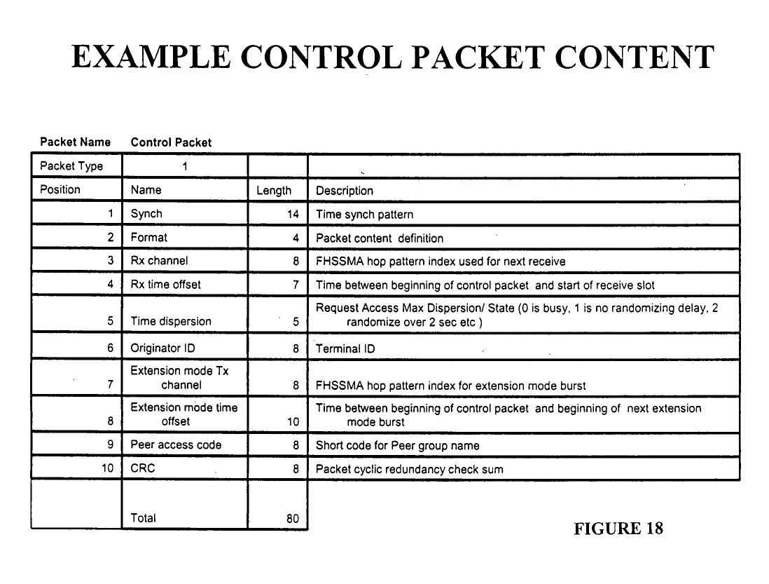

Terminal 1 sends out control messages 30 at regular intervals. The contents of an exemplary control packet are shown in FIG. 18. The first field contains a synchronization bit pattern. The second field describes the packet format and content. The third field gives the frequency hop pattern index for the next five receive timeslot(s) in this embodiment. The possible hop patterns consist, for example, a sequence of 80 channel frequencies pre-selected pseudo-randomly from the available spectrum. A specific pattern can be selected that minimizes the number of frequencies suffering from strong interference. A frequency channel may be subdivided into, for example, four sub channels. Based on the data content, a symbol (or signal) is transmitted in one of the four sub-channels, each representing a separate state. In this example, therefore, each symbol represents two channel bits. The use of forward error correction redundancy, for example, rate one-half reduces the sensitivity to thermal noise and interference and provides one information bit for two channel bits.

The fourth field gives the terminal time offset, that is the time interval between the beginning of the transmission of a control message and the first receive timeslot for that particular terminal. The next four receive timeslots within the five second super-frame are spaced apart by a predetermined interval slightly less the duration of a frame, for example, 124 timeslots. This time slot is continuously decremented to ensure that all time slots are covered, thereby combining normal reception with scanning if the control message, frequency hopping code is also used for reception. Although another terminal receiving the control message will not be synchronized with the originating terminal, the receiving terminal will be able to determine the current time offset of the transmitting terminal relative to its own clock so as to ensure that it transmits to the originating terminal at a time when the originating terminal is available for reception. The receive time search window is wide enough to handle relative clock drifts.

The use of discrete timeslots is important for power consumption. Each terminal goes into a sleep mode wherein most of its circuitry is switched off except when it is transmitting a control message or listening for an incoming message. For example, in an idle state, the receive duty cycle is only 0.8% and the transmit duty cycle is 0.16%.

The fifth field indicates the current maximum time dispersion to be used for access control. A terminal wishing to communicate with a peer will read this parameter and randomly delay its transmission by discrete frames. The maximum delay used by any terminal should not exceed the maximum dispersion value. A value 0 in this field indicates that the terminal is busy and that no accesses should be attempted. The time dispersion is also used to handle short term peaks in load by spreading the traffic out over a longer period of time.

The sixth field gives the short terminal ID of the originating terminal. While the terminals can be given full MAC addresses, more efficiently they can be referenced by a short dynamic ID code unique for the peer group.

The seventh and eighth fields relate to the extension mode channel, which will be discussed in more detail below. The seventh field is essentially equivalent to the third field, and the eighth field is essentially equivalent to the fourth field, for the extension mode. More bits are required since the extension mode requires higher time offset resolution.

The ninth field contains a peer access code, which is used as a first filter to reduce unwanted log-in attempts. It would technically be possible to provide a full peer network ID; however, the multi step filtering method minimizes bandwidth usage and reduces terminal power consumption.

The tenth field is used for error checking.

As shown in FIG. 3, each active terminal MT1, MT2 etc periodically transmits a control message 30. The transmission preferably takes place at regular intervals, although this is not essential. The control message serves to indicate the presence of a terminal in the peer group and also impart information, such as timing information, and frequency hopping code to the other terminals about the transmitting terminal. If a frequency hopping technique is employed, instead of sending the actual hopping code, it is possible to store an indexed list of available hopping codes in a table at each terminal. In this case, it is only necessary to transmit the index. The receiving terminal then looks up the appropriate code in its table.

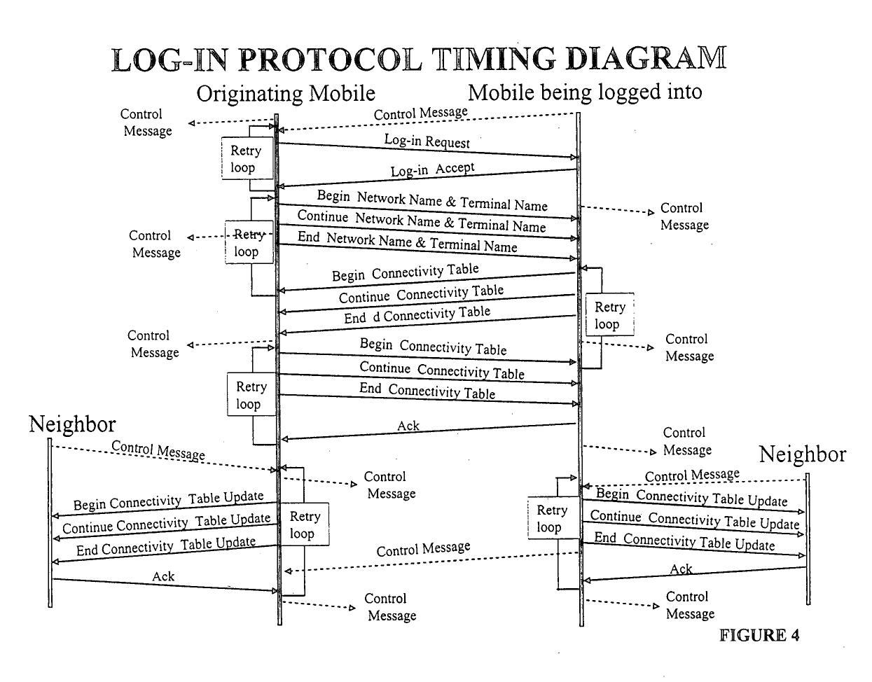

FIG. 4 illustrates the detailed log in sequence for a new terminal wishing to join the peer group. When an existing terminal detects the presence of control messages from a new neighbor which contains the proper peer network access code (ninth field), a log in request is transmitted to that neighbor. The log in request message includes a short terminal identification code. The log in request will be accepted and acknowledged if the terminal short access code is valid for the particular peer group. The log in originator will then start transferring both the full terminal and peer network name. If both names are valid the terminal being logged into will transfer its current connectivity information. The terminal which has just logged in will in turn transfer its connectivity information if it has valid connections to other peers. The login process is divided into multiple steps, each performing a data transfer, ARQ, and automatic repeat mechanisms. The initial packet can specify a multi-packet transmission and instruct the receiving terminal to stay on for a number of specified timeslots, which may, but need not necessarily, be consecutive. The final packet in a multi-packet transfer contains necessary channel information to permit the ARQ function. In addition to the connectivity table, each peer keeps track of the time offset of its own control messages relative to the control messages of each peer that it is logged into. This information is used to track peers that are already logged into the peer group. It is also used as an additional filter to differentiate from terminals belonging to a separate peer group, but which use the same terminal short ID and peer access code.

In the special case of a terminal first being powered up, a fast scan for control messages with the proper peer access code is performed to detect the presence of any peers. This is followed by the log in process described above.

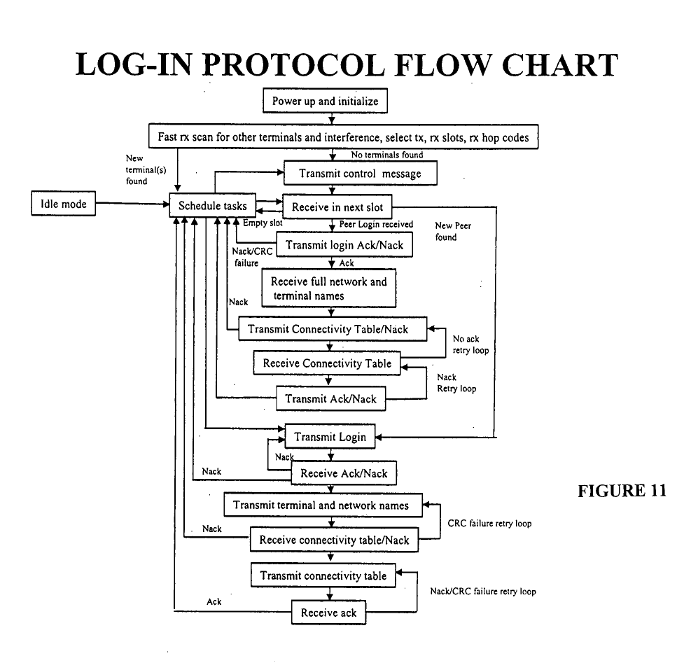

The flow chart shown in FIG. 11 further elaborates the login procedure. A terminal task scheduler controls this process which can be entered upon initial power-up or upon detection of a new control message from an adjacent terminal. The scheduler prioritizes and schedules tasks according to the various states in the protocol.

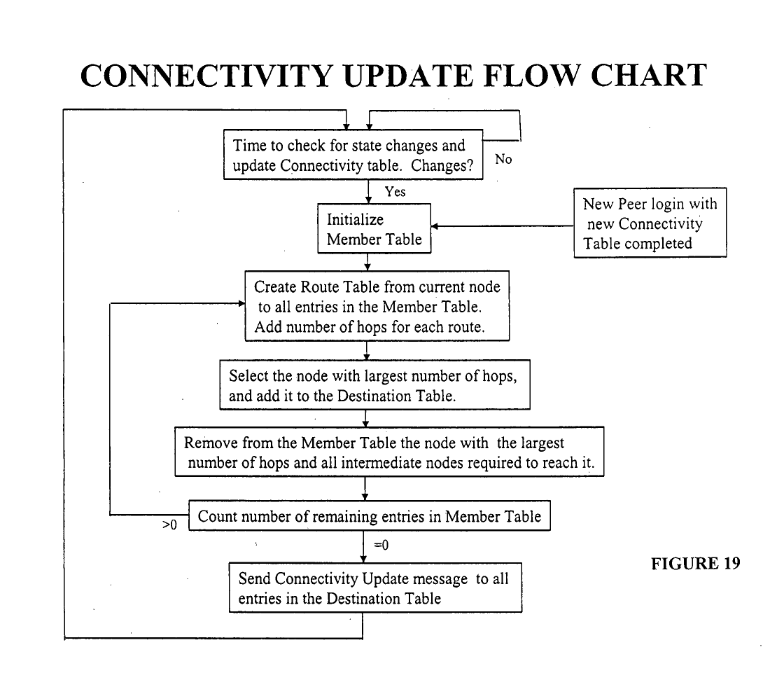

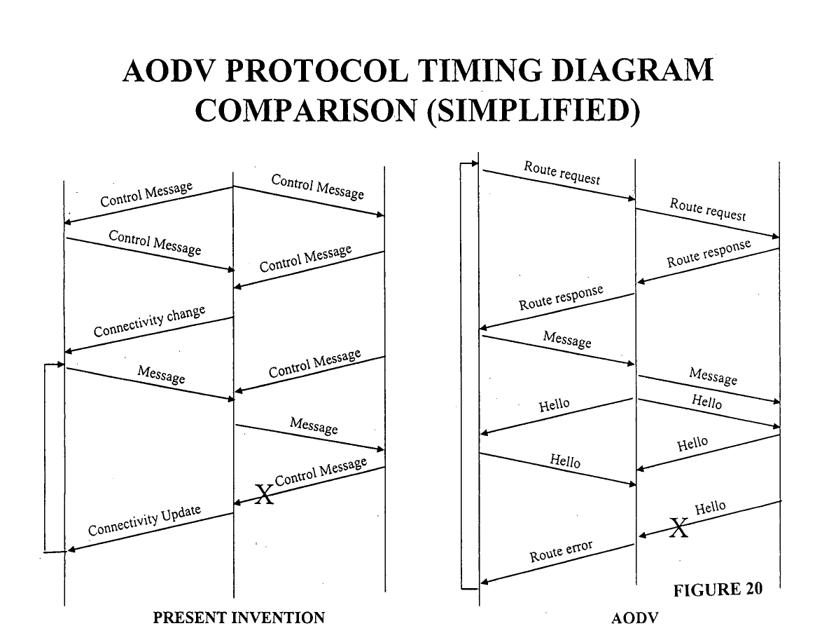

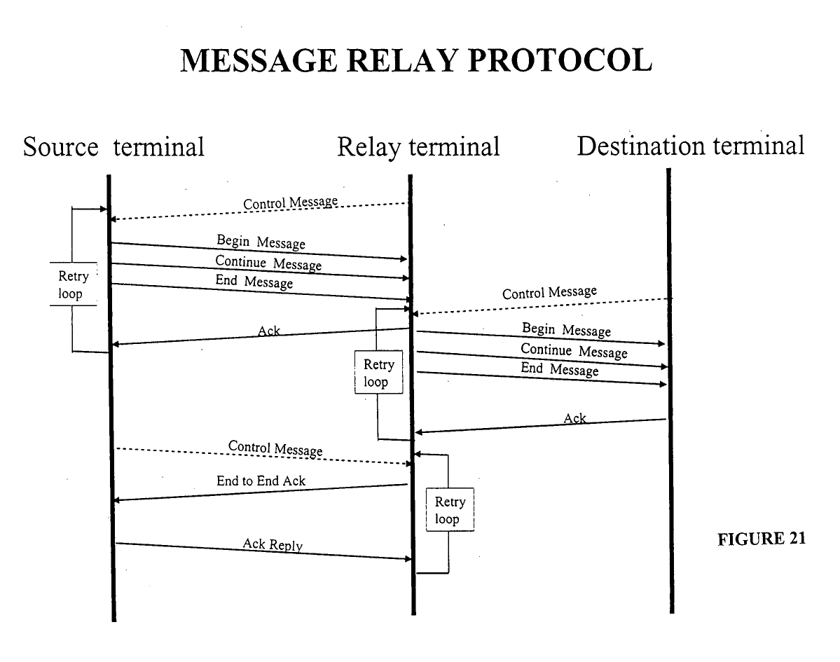

The algorithm shown in FIG. 19 illustrates an example of the creation of specific routing paths and the dissemination of connectivity table updates to the other peers within the network. These updates are sent to the terminals that cannot be accessed directly, which allows intermediate relaying terminals to update their tables as this information progresses towards its final destinations. Through this process the originator ensures that all terminals receive the necessary updates while keeping the number of transmissions to a minimum. If only a few lines in the Connectivity Table need updating because all other links remain intact, only these will be sent. Acknowledgements and retries are used for all transfers. A terminal can also request a complete connectivity table from a neighbor when required.

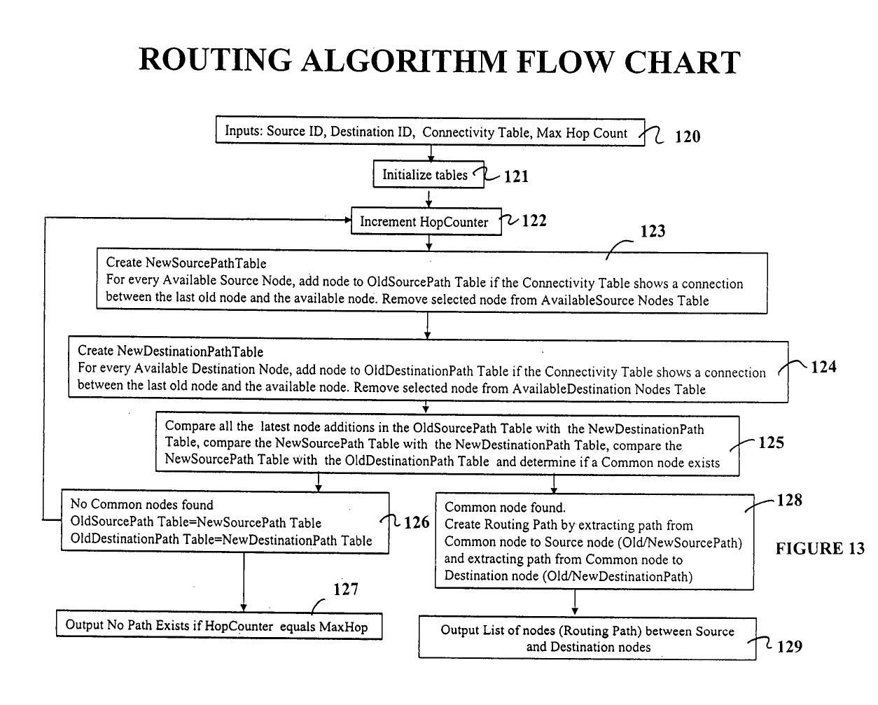

In the messaging mode, the message originator uses the instantaneous connectivity table to determine the best first hop to use for message routing to a recipient. The preferred routing is usually based on hop minimization, but may also take into account recent link quality information such as signal to noise ratio, number of retransmissions required and traffic loading, which can be determined by the access control value. The routing algorithm shown in FIG. 13 or a simple iterative search is used to minimize number of hops. In a typical example, a relay terminal will normally re-determine the best routing from its connectivity table as the message progresses towards its destination address.

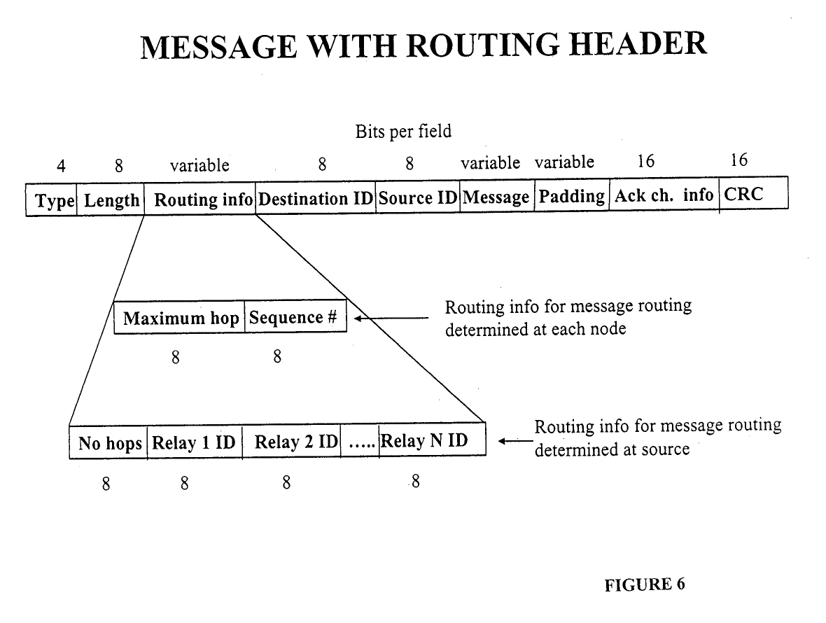

The augmented message, shown in FIG. 6, contains message type, message length, source ID, destination ID, routing information, the message, ack channel information, padding and a checksum. The routing information for a message routed at source (e.g. connectivity table update) includes the number of hops and the ID of each hop. A message routed in flight contains a maximum hop number and a message sequence number used to prevent messages from becoming trapped in a loop.

Referring now to FIG. 13, an originator terminal selects the shortest route (minimum hops) to the recipient. This may require the use of one or multiple relay stations. The algorithm essentially traces back all paths from both the source and destination using the connectivity table entries to find a common node, and then traces back to the source and traces forward to the destination node to determine the full routing path. At step 120, the processor uses as inputs, the source ID, destination ID, data from the connectivity table and maximum hop count. At step 121, the processor initializes the tables. At step 122, the processor increments the hop counter. At step 123, the processor creates a new source path table, and for every available source node adds a node to the old source path table if the connectivity table shows a connection between the last old node and the available node.

At step 124, the processor creates a new possible destination path table. At step 125 all the latest node additions in the old and new source path tables are compared with the destination path tables to determine if a comunon node exists. If no common nodes are found, the old source path table is set to the new source path table and the old destination path table is set to the new destination path table at step 126. At step 127, the processor concludes that no path exists if the hop counter equals the maximum hop.

At step 128, if the first common node is found the processor creates the routing path and outputs a list of nodes between the source and destination nodes (Step 129).

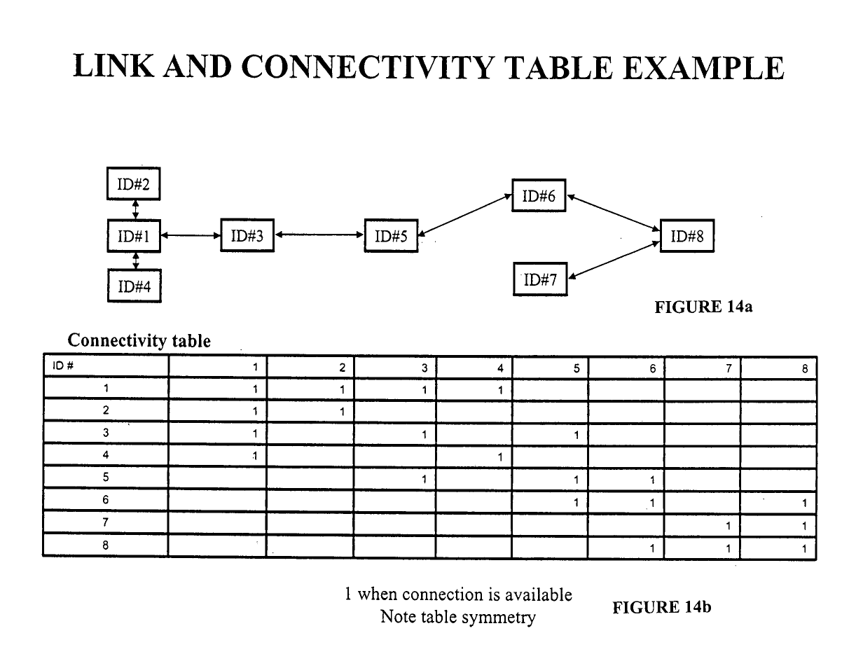

FIG. 14a shows a connection path from terminal with source ID#1 to terminal with destination ID#8. In order to get to terminal #8, a packets is sent from terminal ID#1 to terminal ID#3, which relays it to terminal ID#5, which in turn relays it to terminal ID#6, which relays the message to the final destination, namely terminal ID#8. This information is extracted from the connectivity table as explained above with reference to FIG. 5. FIG. 14b shows the corresponding connectivity table for this example.

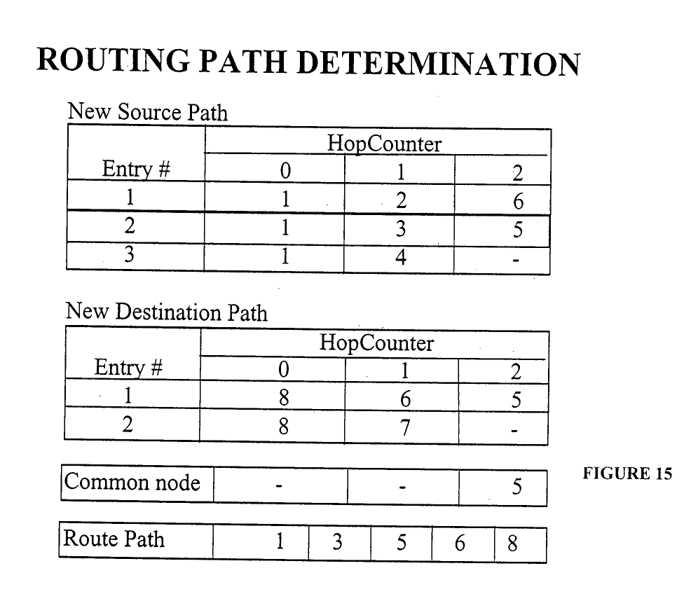

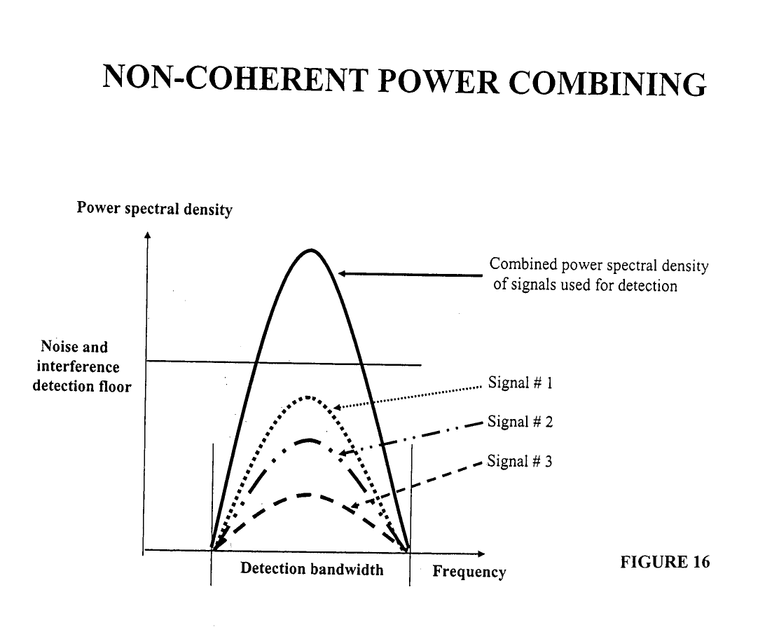

FIG. 15 shows exemplary contents of the source and destination path tables during operation of the routing algorithm for the example shown in FIG. 14a.

The essence of the system is that all the terminals operate on a peer to peer basis. No single terminal has control over the other. Each terminal continually updates its connectivity table describing the connection state of the system, and derives a routing path when required to any peer terminal. Thus, when one terminal comes on line, its control message is received by all terminals within direct range and they update their connectivity tables to recognize the presence of the new terminal. They in turn transmit control messages to update the connectivity tables of terminals not within direct range of the first terminal so that the update information is continually propagated through the peer group and all terminals have up-to-date information about all other reachable terminals in the system.

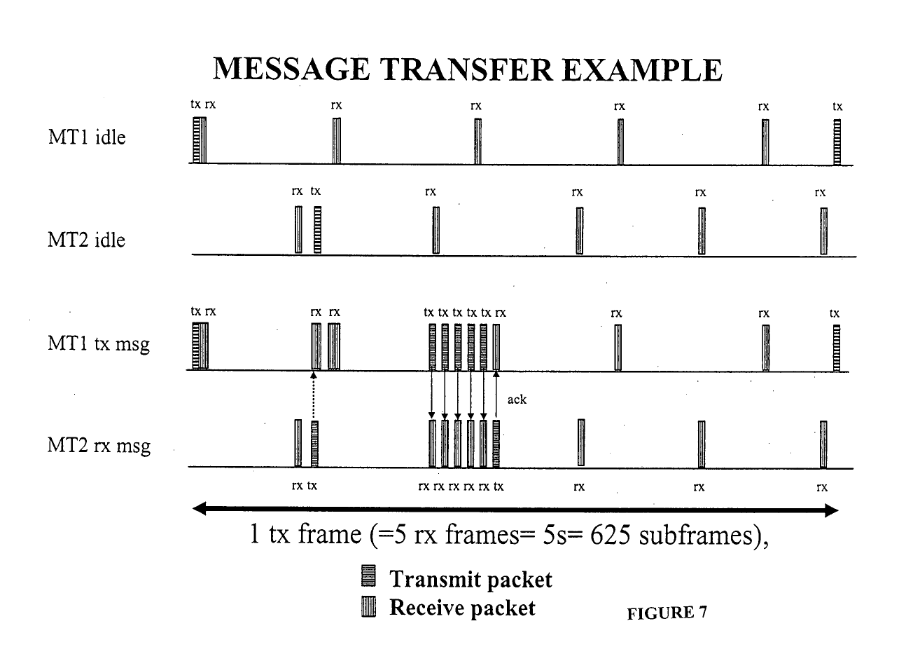

FIG. 7 shows one example of a data message transfer between peer terminals. Terminals MT#1 And MT#2 transmit control message 30. When terminal MT1 wants to send a message to terminal MT2, it sends a begin message to terminal MT2 which enables this terminal to receive all subsequent packets (which due to processing time constraints in the terminal may include short pauses between packet transmissions) including the last packet containing ack channel information. MT2 uses the ack information to send an ack message to MT1 with the right hopping code and timeslot for terminal MT1. A terminal receiving a begin message packet will keep the receiver on until the last packet is received.

The terminals also transmit a group extension control message 31, which enables them to act in a co-operative extended range mode to increase the range of the terminals. If all members of a sub-group of terminals are out of direct range with terminals forming part of another sub-group, the terminals can transmit in unison to increase the range and also overcome the effects of ground obstructions and the like.

In the range extension mode, a sub-group of terminals is instructed to transmit the same data messages nearly simultaneously at a particular time in order to combine the power and provide path diversity. This mode of operation is similar to the ordinary mode using both periodic control messages and standard data messages except that the terminals act co-operatively to enhance the effective range of the sub-group.

An extension mode control message is transmitted by each terminal in addition to the ordinary control message referred to above. The extension mode control message contains time and frequency information for group reception. The exact transmit time slot and frequency for the extension mode is set by the first terminal to power up. At the appointed time, every terminal transmits at intervals a nearly simultaneous identical control message containing receive channel information, such as hopping code and receive slot timing offset and access station connectivity for the extension sub-group. The extension mode receive time slot is continuously decremented to ensure that all time slots are covered, thereby combining normal reception with scanning.

When it is desired to transmit a data message in the extended range mode, a data message is first broadcast to all local terminals using the same protocol that is used for the network connectivity table distribution with an indication that this message is to be re-broadcast in the extension mode.

At the appointed time, all terminals in the extended range sub-group re-transmit the received message using the same frequency hopping code. Any terminal in a second sub-group in extension mode receiving this message will try to route this message to its destination if a path exists.

When the destination terminal receives the message, the acknowledgement message is returned to the originating terminal using the same transmission method.

The terminals communicate using a non-coherent modulation method, such as 4-tone mfsk, where detection is based on total energy within a narrow frequency band. One of the important advantages of such a modulation technique is that the power can be added non-coherently even with minor frequency offsets. The effect of timing errors on inter-symbol interference is minimized by the use of frequency hopping for every symbol.

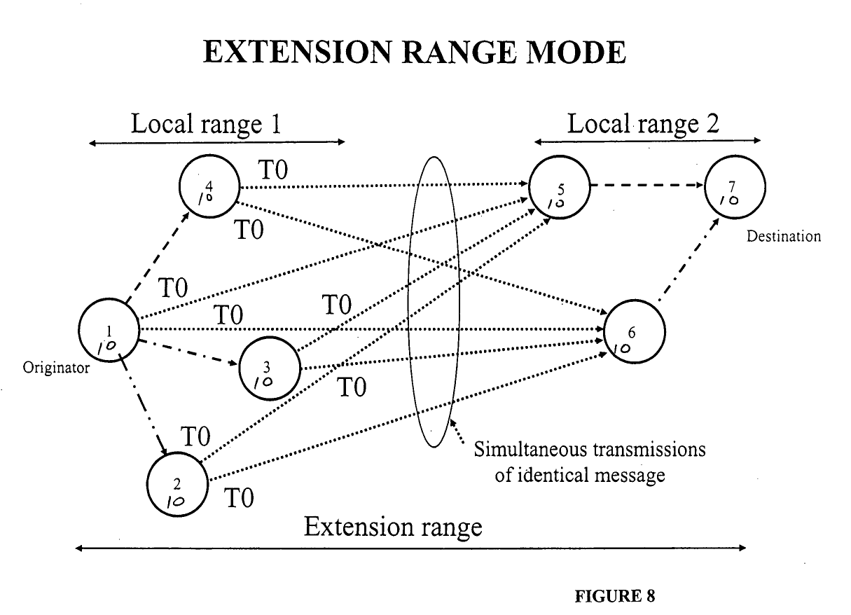

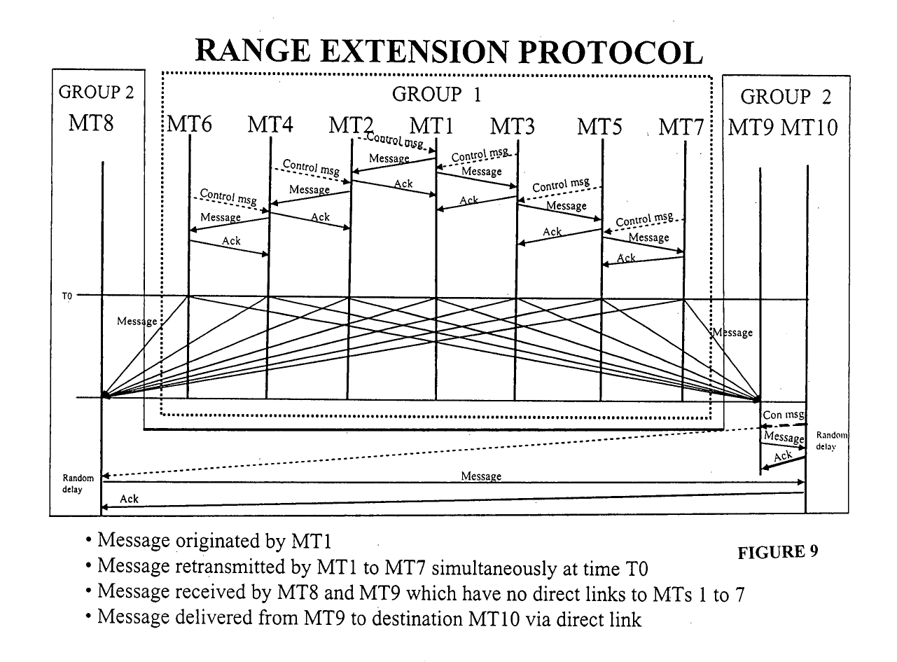

In FIG. 8, assuming that none of the terminals of sub-group (local range) 1 can reach directly any of the terminals of sub-group (local range) 2, it is still possible to establish communication between terminals in these two sub-groups using the extended range mode. In this mode, the originating terminal 10¹ sends an extended range message request to all other terminals in its sub-group (10², 10³, 10⁴). They nearly simultaneously re-transmit the message at the appointed time. This is then picked up by all terminals within range of the transmitting extended sub-group in the receiving extended sub-group.

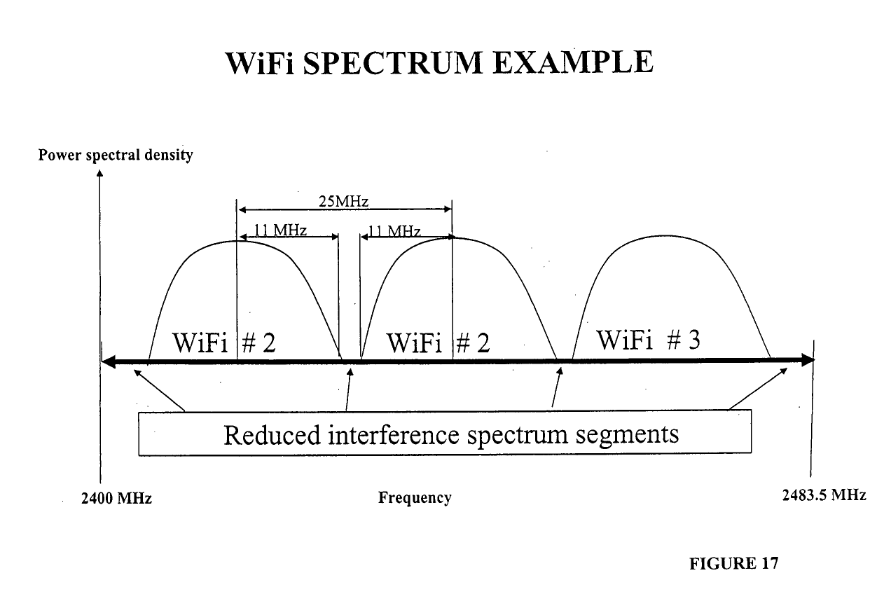

Since the terminals are not synchronous, even though they will delay the message for a suitable period so that they all transmit generally at the same time, the messages will not be exactly synchronized. However, since the receiving terminals 105 and 106 are merely looking for the total energy, as long as the terminals are transmitting at approximately the same frequency and at approximately the same time, the receiver will use the total energy received for detection. This effect is shown in FIG. 17. The energy received at any particular frequency will depend on the total power being transmitted at any instant, and even though the frequency profiles in the time domain may not exactly line up, the powers will sum and the receiver will see increased power in the frequency of interest. Moreover, if multiple signals are received from different paths at the same time, the probability that multiple signals suffer maximum fading simultaneously is much reduced relative to a single path. This concept of non-coherent combining has important applications in other fields where it is desired to extend the range of a signal. Similar results would not be obtained, for example, with coherent direct sequence spread spectrum techniques because the signal energy would only be constructively combined with tight synchronization of phase, frequency and time or the use of complex signal processing.

FIG. 3 shows the group control message 31 transmitted by the sub-group 1. This control message contains all the information about the sub-group that is required for communication with another sub-group that is not within direct range of any of the terminals in the first sub-group. In the example of FIG. 3, each terminal MT1, MT2, MT3 sends out the group control message 31 at the same time. In extended range mode, the originating terminal distributes a message that it wishes to a send to at terminal in group 2. It may take several hops for this message to reach all the terminals in its sub-group 1. All the terminals then transmit the message at the same time and after a predetermined delay sufficient for the message to propagate throughout the group. The energies in the different frequencies add as explained above to extend the range of the group beyond the individual range of any one terminal.

The extended range message may be received by more than one terminal of sub-group 2, in this case, terminals 10⁶ and 10⁶. Both these terminals forward the message to the destination terminal, terminal 10⁷, but after introducing a random delay to avoid collisions.

Terminals connected directly or via relay stations to different access stations 15 can communicate using the Internet to route the messages between access stations. Each access station maintains a list containing the names, IP address of other access stations in addition to its connectivity table. Apart from this additional functionality, each access station behaves in exactly the same manner as other terminals in the system. The access stations can relay messages and participate in a group transmission in the extended range mode in exactly the same way as the other terminals. The present invention also envisions dual mode terminals that provide Internet access point functionality using standard wireless connections such as WiFi.

Upon first time power up, an access station 15 determines its own IP address, and is given its access station name and the name or IP address of another access station in the network that is active. The access station will then connect to the other access station and get the connectivity table, network name (buddy list name), terminal short numbers, terminal full names, network access code and transmit channel code (frequency & spread spectrum frequency hop code). The access station will search for other access stations on its list until one is found to be online. The date and time may be retrieved from an Internet time server.

Unlike the mobile terminals, which are battery operated, the access station 15 will generally be operated from the public utility supply. Since it does not have any power constraints, unlike the mobile terminals, it can continuously scan all timeslots and log into mobile terminals as they are found.

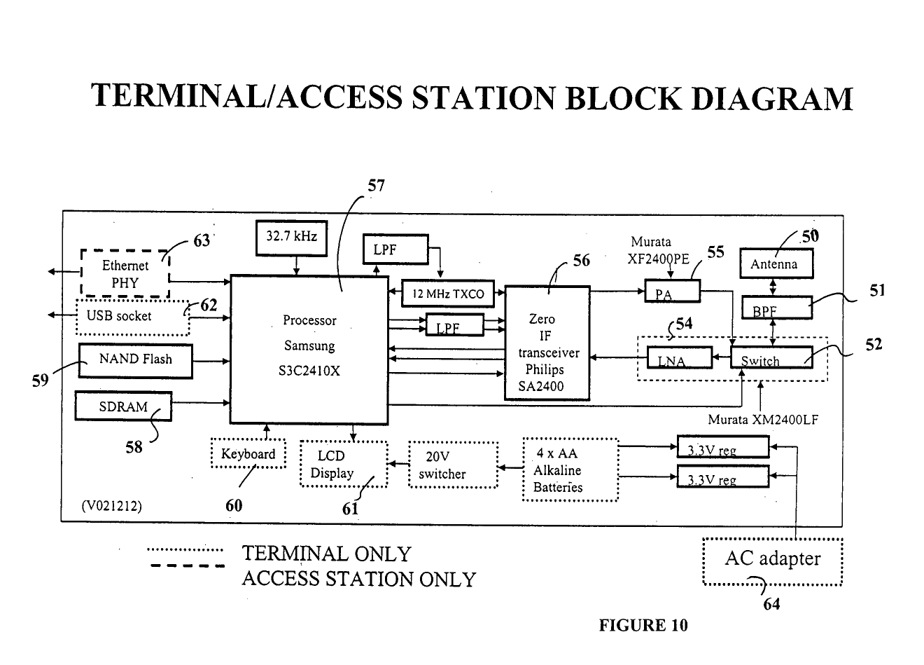

FIG. 10 is a block diagram of a terminal and an access station. The terminal includes an omni directional antenna 50, which can be a quadrifilar helix, short whip or a dielectric rod. The antenna 50 is connected to a solid state RF switch such as the NEC UPG2015TB through a band pass filter 51. The switch connects the antenna to either the receive chain 54 or the transmit chain 55.

The receive chain consists of a LC input filter, a low noise amplifier, a mixer driven by a synthesizer and a quadrature downconverter. The quadrature down converter provides both RF and baseband gain. The output of the quadrature downconverter is filtered using operational amplifier based low pass filters that interface to the processor 57.

The transceiver 56 is a zero IF Philips SA2400. It includes a synthesizer driven by a tunable reference oscillator, a voltage controlled oscillator, a passive loop filter and a digital synthesizer containing a programmable frequency divider and frequency/phase detector. The coarse receive and transmit center frequencies are set by changing the division ratio of the synthesizer. The fine frequency adjustment is obtained by tuning the reference oscillator. The baseband subsystem provides filtered in-phase and quadrature signals used to provide multiple frequency shif keying modulation. The output of the VCO is amplified and filtered and connected to the antenna switch 52.

The baseband subsystem for processing the signals in this example consists of a microprocessor 57, such as a Samsung S3C2410X with its associated RAM 58, which stores the connectivity table, and Flash memory 59. The processor 57 receives quadrature samples from the receive chain. An FFT (Fast Fourier Transform) based algorithm is used to demodulate the signal and extract the digital data. A forward error correction decoder (implemented in software) converts the channel symbols into reliable information bits. Alternatively, the microprocessor 57 could be replaced by a digital signal processor. The processor 57 is connected to a keyboard 60, which can be a low cost membrane switch matrix that interfaces directly to the processor 57. Sixteen lines from the processor 57 provide an 8×8 switching matrix. Debouncing is done in software. A low cost LCD display 61 with built in driver for displaying received messages and other data connects to the processor 57.

The unit is powered by 4 AA Alkaline batteries. Low dropout linear voltage regulators are used to provide clean and stable supplies. The low duty cycle of the active circuitry, which is placed in an inactive sleep mode during inactive timeslots, ensures a long battery life. The Samsung S3C2410X processor 57 has a built in sleep mode timer driven by a 32 KHz clock generator.

The terminal can optionally be provided with a USB slot 62 for communication with a computer or other peripheral device. The USB interface can be used for downloading information or data, such as music. Game packs, GPS devices and additional flash memory can also be installed.

When the terminal is acting as an access station, it is provided with an Ethernet interface 63. The Ethernet interface 63 conditions the physical level signals and interfaces to the protocol software residing in the microprocessor 57.

In the case of an access station, power is provided by standard 115VAC wall adapter 64. Low dropout linear voltage regulators are used to provide clean and stable supplies to the various subsystems.

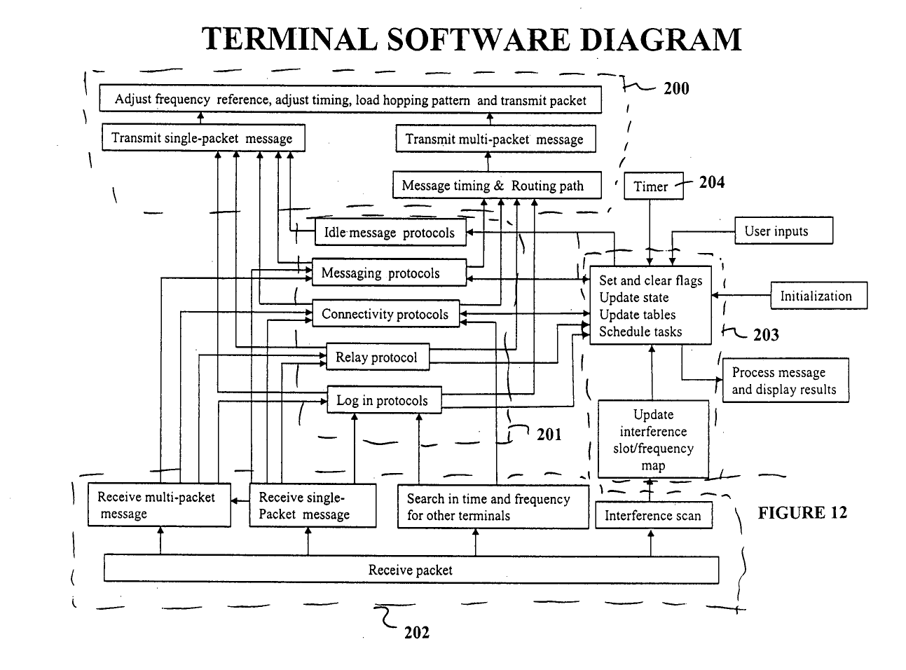

FIG. 12 is a high level flow chart showing the detailed operation of the processor 57, which can awakened in response to user input through, for example, the keyboard 60. Also, it will periodically be awakened in its designated timeslot by timer 204 to listen for incoming messages. The processor carries out a number of tasks when it is in the steady state. These are divided into four main blocks. Block 200 shows the transmit routines, block 202 shows the receive routines, block 201 shows the message protocols, and block 203 shows the scheduler controlling the performance of the various tasks.

Various other processes that can occur include the receipt of an ack message, the receipt of a long message, updating the connectivity table, relaying a message for another terminal, transmitting an ack message, preparing a message routing path based on knowledge of the state of the system learned through the control messages, selecting an optimum hopping pattern, updating an interference map, and checking connectivity with other terminals.

The optimum hopping pattern is selected to minimize interference with other sources of energy as illustrated in FIG. 18. This figure shows interfering WiFi transmissions occupying most of the band. The WiFi signals are 22 MHz wide, often spaced on a 5 MHz grid. This invention employs narrowband transmission, which allows the system to support a large number of independent and unsynchronized peer groups in the same coverage area. In this example, the individual frequency channels are 80 KHz wide, and any frequency can be chosen within the 83.5 MHz allocated bandwidth. A hopping pattern can be chosen that employs frequencies that minimize interference with existing signals. In this case, for example, a hopping pattern can be chosen that puts most of the energy in frequency segments between the WiFi signals, or at the band edges, and thus minimizes interference with WiFi. For example, in FIG. 18, frequencies would be selected from the hopping code that fall between the WiFi signals as far as possible and also between any other interfering signals that are present, whether from other terminals or external sources. The terminals can maintain an interference map on an ongoing basis indicating which parts of the spectrum currently contain the most energy so as to permit the selection of hopping patterns that minimize interference.

The access stations can be either public or private. Preferably, public access stations are a multichannel version of the private access stations using a more powerful processor. The transmit signals of the multichannel access station are combined before the antenna using a passive combiner. The received signal is split after the low noise amplifier and distributed to individual receive chains with their associated synthesizers.

It will be appreciated by one skilled in the art that many variations of the invention are possible within the scope of the appended claims. In particular, a person skilled in the art will appreciate that the invention can be implemented in different ways. For example, it would be possible to distribute the tasks among several processors, or implement the invention using logic circuitry, such as ASICs, or even discrete components. The invention extends to all such implementations.

We claim:

1. A wireless data communication system comprising:
a plurality of data terminals, at least some of which are mobile and which are organized into one or more peer groups forming a dynamic mesh-like network of connection paths between any of said terminals either directly or via intervening peer terminals; and
each said terminal having a sleep mode in which said terminal consumes minimal power and is inoperative to receive wireless communications, and an active mode during which said terminal is operative to receive direct wireless communications from nearby peer terminals within reception range, said terminal including:
a transceiver to permit the direct exchange of wireless messages containing routing information including a destination address with any nearby peer terminal;
a memory for storing a connectivity table containing the connection paths to other terminals within said one or more peer groups; and
a processor, said processor being programmed while in said active mode to:
(i) to transmit at intervals control messages containing characteristic information necessary for said nearby terminals to communicate with said terminal;
(ii) to exchange status messages with nearby terminals to update said connectivity table;
(iii) to prepare an outgoing data message with routing information that depends on an instantaneous operational state of the terminals in said system; and
(iv) to extract routing information contained within incoming data messages having a destination address and, when said routing information in said incoming data messages contains an identification code of said receiving terminal, either present a received message for local processing in said receiving terminal if said destination address corresponds the address of the receiving terminal or else to relay said incoming data message to another terminal on a connection path to the destination address.

2. The wireless data communication system as claimed in claim 1, wherein said characteristic information includes timing information defining timeslots when said terminal is active to receive incoming wireless communications.

3. The wireless data communication system as claimed in claim 1, wherein said wireless communications are exchanged using a frequency hopping technique and said characteristic information further includes information about a frequency hopping code.

4. The wireless data communication system as claimed in claim 1, wherein information about said frequency hopping code is an index to a table stored in said terminal containing a list of usable frequency hopping codes.

5. The wireless data communication system as claimed in claim 1, wherein said wireless communications are exchanged using a direct sequence spread spectrum technique and said characteristic information is a direct sequence spread spectrum code.

6. The wireless data communication system as claimed in claim 1, wherein said processor at an originating terminal is programmed to establish complete routing information for an outgoing data message from its connectivity table to the destination terminal and insert said complete routing information in said outgoing data message.

7. The wireless data communication system as claimed in claim 6, wherein said processor is programmed to update said routing information contained in an incoming data message.

8. The wireless data communication system as claimed in claim 1, wherein said processor, in response to the receipt of an incoming data message containing the address thereof and a different destination address, is programmed to establish routing information from its connectivity table to said destination address and relay said incoming message to another terminal determined by said routing information and forming a next hop in the connection path to the destination address.

9. The wireless data communication system as claimed in claim 3, wherein said terminals are programmed to scan for active frequencies and choose a frequency hopping code having frequency components that minimize interference with existing transmissions.

10. The wireless data communication system as claimed in claim 1, wherein at least one of said terminals is a fixed access station.

11. The wireless data communication system as claimed in claim 1 0, wherein said fixed access station is connected to a fixed network.

12. The wireless data communication system as claimed in claim 13, wherein said fixed network is connected to data servers.

13. The wireless data communication system as claimed in claim 12, wherein said network is the Internet.

14. The wireless data communication system as claimed in claim 13, wherein said fixed access station is connected via said network to another access station communicating with at least one other data terminal of said peer group.

15. The wireless data communication system as claimed in claim 14, wherein said fixed access stations are programmed to update their respective connectivity tables over said fixed network.

16. The wireless data communication system as claimed in claim 1, wherein said processor of each terminal is responsive to receipt of an extended range message from an originating terminal within range to generate a delayed transmission of said extended range message synchronized with a delayed transmission thereof from other terminals and thereby extend the transmission range of the originating terminal.

17. The wireless data communication system as claimed in claim 16, wherein each terminal includes a memory area for storing a received extended range message from the originating terminal until synchronized transmission thereof.

18. The wireless data communication system as claimed in claim 17, wherein said extended range message specifies the time of synchronized transmission thereof by said terminals participating in the synchronized transmission.

19. The wireless data communication system as claimed in claim 18, wherein terminals within a said peer group are organized into extended range groups, and each terminal within an extended range group simultaneously transmits an extended range group control message to establish the presence of said extended range group and provide information necessary for other extended range groups to communicate therewith in an extended range mode by simultaneous transmission.

20. The wireless data communication system as claimed in claim 19, wherein said terminal within an extended range group maintains timing information for other terminals within said extended range group so as to provide timing offset information for the extended range group and thereby ensure simultaneous transmission of said group control message.

21. The wireless data communication system as claimed in claim 20, wherein said group control message identifies a timeslot during which a said wireless message can be received.

22. The wireless data communication system as claimed in claim 1, wherein the terminal transmitting said control message scans for channel activity over a period of time and transmits said control message in an idle time slot selected to minimize interference with existing transmissions.

23. The wireless data communication system as claimed in claim 1, wherein said processor is responsive to a login message to permit access of the associated terminal to a peer group.

24. The wireless data communication system as claimed in claim 23, wherein said login message comprises a short message to initiate a login procedure, and a longer message to complete a login procedure after initiation thereof by said short message.

25. The wireless data communication system as claimed in claim 1, wherein said messages are exchanged in timeslots and said control message is transmitted in a time slot that is selected according to channel activity to optimize interference with other terminals.

26. A data terminal for use in a wireless data communication system comprising a plurality of data terminals organized into one more peer groups forming a dynamic mesh-like network, at least some of said data terminals being mobile, a transceiver to permit the direct exchange of wireless messages containing routing information including a destination address with any nearby peer terminal, said terminal having a sleep mode in which said terminal consumes minimal power and is inoperative to receive wireless communications, and an active mode during which said terminal is operative to receive direct wireless communications from nearby peer terminals within reception range, and said terminal comprising:
a memory for storing a connectivity table containing the connection paths to other terminals within said one or more peer groups; and
a processor, said processor being programmed while in an active mode to:
(i) to transmit at intervals control messages containing characteristic information necessary for said neighboring terminals to communicate with said terminal;
(ii) to exchange status messages with nearby terminals to update said connectivity table;
(iii) to prepare an outgoing data message with routing information that depends on an instantaneous operational state of the terminals in said system; and
(iv) to extract routing information contained within incoming data messages having a destination address and, when said routing information in said incoming data messages contains an identification code of said receiving terminal, either present a received message for local processing in said receiving terminal if said destination address corresponds the address of the receiving terminal or else to relay said incoming data message to another terminal on the connection path to the destination address.

27. The data terminal as claimed in claim 26, wherein said processor is programmed to generate a control message that is transmitted at intervals to other terminals to provide information necessary for other terminals to communicate therewith.

28. The data terminal as claimed in claim 27, wherein each said terminal includes its own asynchronous internal clock and said control message includes timing information necessary for other terminals to communicate therewith.

29. The data terminal as claimed in claim 28, wherein said messages are exchanged in timeslots and said timing information identifies a timeslot relative to the internal clock of the transmitting terminal during which a said wireless message can be received.

30. The data terminal as claimed in claim 36, wherein said control message identifies a frequency hopping code for establishing communication with the transmitting terminal.

31. The data terminal as claimed in claim 30, further including a memory for storing a dynamic connection table identifying a connection path between any two terminals of a peer group.

32. A method of establishing communication between a plurality of data terminals, at least some of said data terminals being mobile, comprising the steps of:
organizing a plurality of data terminals, at least some of which are mobile, into one or more peer groups forming a dynamic mesh-like network of connection paths between any of said terminals either directly or via intervening peer terminals, each said terminal having a sleep mode in which said terminal consumes minimal power and is inoperative to receive wireless communications, and an active mode during which said terminal is operative to receive direct wireless communications from nearby peer terminals within reception range;
(i) transmitting at intervals control messages containing characteristic information necessary for said nearby terminals to communicate with the originating terminal;
(ii) exchanging status messages with nearby terminals to update a connectivity table containing connection paths to other terminals within said one or more peer groups;
(iii) preparing an outgoing data message with routing information that depends on an instantaneous operational state of the terminals in said system; and
(iv) extracting routing information contained within incoming data messages having a destination address and, when said routing information in said incoming data messages contains an identification code of said receiving terminal, either present a received message for local processing in said receiving terminal if said destination address corresponds the address of the receiving terminal or else to relay said incoming data message to another terminal on a connection path to the destination address.

33. The method as claimed in claim 31, wherein a control message that is transmitted at intervals from each terminal to other terminals to provide information necessary for other terminals to communicate therewith.

34. The method as claimed in claim 33, wherein said control message includes timing information necessary for other terminals to communicate therewith.

35. The method as claimed in claim 34, wherein said messages are exchanged in timeslots and said timing information identifies a timeslot relative to an internal clock of the transmitting terminal during which a said wireless message can be received.

36. The method system as claimed in claim 35, wherein said terminals employ a frequency hopping code, scan for active frequencies and select a frequency hopping code having frequency components that minimize interference with existing transmissions.

37. A wireless data communication system comprising:
a plurality of data terminals, at least some of which are mobile and which are organized into one or more peer groups forming a dynamic mesh-like network of connection paths between said terminals; and
each said terminal having a sleep mode in which said terminal consumes minimal power and an active mode, said terminal including:
a transceiver to permit the direct exchange of wireless messages containing routing information including a destination address with any other terminal within range;
a memory for storing a connectivity table containing the connection paths to other terminals within said one or more peer groups;
means for exchanging control messages with neighboring terminals so that state changes are distributed throughout the communication system;
means for monitoring the state of said connection paths at intervals and updating its associated connection table in response to changes in state;
means for preparing an outgoing message with routing information that depends on the instantaneous state of the system; and
means for extracting routing information contained within incoming wireless messages and, when said routing information in said incoming wireless messages contains an identification code of said receiving terminal, either present a received message for local processing in said receiving terminal if said received message is addressed thereto or relay said received message to another terminal so as to provide a said connection path.
